(19) United States
(12) Patent Application Publication
(10) Pub. No.: US 2015/0117830 A1
(43) Pub. Date: Apr. 30, 2015

(54) Light tracks for media content

(71) Applicant: Google Inc., Mountain View, CA (US)

(72) Inventor: Alexander Faaborg, Mountain View, CA (US)

(73) Assignee: Google Inc., Mountain View, CA (US)

(21) Appl. No.: 14/067,090

(22) Filed: Oct. 30, 2013

(51) Int. Cl. G11B 31/00; H04N 5/85; G11B 27/34; G11B 27/10; G11B 27/32

(52) U.S. Cl. CPC G11B 31/00; G11B 27/105; G11B 27/32; G11B 27/34; H04N 5/85
USPC 386/200

(57) ABSTRACT

Systems and techniques are disclosed for generating a light calibration profile based on one or more light emitters. A light track associated with a media track may be mapped onto the one or more light emitters based on the light calibration profile and the one or more light emitters may be activated based on the mapping. The media track that the light track is associated with may be a video track, audio track, or text track and the light track may correspond to aspects of the media track. The light track may contain light activation indications based on timestamps or other metadata.

### BACKGROUND

Traditionally, media content, such as a video clip, that is displayed on a display, such as a television, is accompanied by an audio track. The audio track is associated with the video track such that the audio track corresponds to a frame or set of frames on the video track. As an example, a scene in a video track that shows an actor yelling may be accompanied an audio track that contains the actor's voice at a high decibel level. Thus, sound content is coordinated with visual content for the video.

### BRIEF SUMMARY

According to implementations of the disclosed subject matter, a light calibration profile may be generated based on at least a first light emitter and may be generated based on a first and second light emitter. The light calibration profile may be generated by a processing device that is associated with a media track player. The light calibration profile may be generated based on transmitting an audio signal via a calibration speaker, receiving the audio signal at an audio receiver located at a light emitter, and generating the light calibration profile based on at least a characteristic of receiving the audio signal. Alternatively or in addition, the light calibration profile may be generated based on transmitting an audio signal from a first audio transmitter located at a light emitter, receiving the audio signal at a calibration receiver, and generating the light calibration profile based on at least a characteristic of receiving the audio signal. Alternatively or in addition, the light calibration profile may be generated based on transmitting a light signal via a calibration emitter, receiving the light signal at a light receiver located at a light emitter, and generating the light calibration profile based on a characteristic of receiving the light signal. Alternatively or in addition, the light calibration profile may be generated based on transmitting a light signal from a light emitter, receiving the light signal at a calibration receiver, and generating the light calibration profile based on at least a characteristic of receiving the light signal. A light track associated with a media track (e.g., a video file, an audio file, a text file, etc.) may be received and may be mapped onto at least the first and/or second light emitter based on the calibration profile. The first and/or second light emitter may be activated based on the mapping. The light track may contain light activation indications based on timestamps, metadata, or the like and may be generated using a light box. The calibration profile may contain characteristic information such as a light emitter location, a light emitter location relative to a reference point, a light emitter type, a light emitter orientation, a light emitter emission range (e.g., possible light emission colors, color temperatures, luminance, hue, saturation, etc., that a light emitter is capable of emitting), or the like.

Systems and techniques according to the present disclosure provides users with a richer visual experience while being exposed to media content. Additional features, advantages, and implementations of the disclosed subject matter may be set forth or apparent from consideration of the following detailed description, drawings, and claims. Moreover, it is to be understood that both the foregoing summary and the following detailed description include examples and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

FIG. 1 shows a computer according to an implementation of the disclosed subject matter.

FIG. 2 shows a network configuration according to an implementation of the disclosed subject matter.

FIG. 3 shows an example process for activating a light emitter, according to an implementation of the disclosed subject matter.

FIG. 4a shows an example illustration of a room with light emitters, according to an implementation of the disclosed subject matter.

FIG. 4b shows another example illustration of a room with light emitters, according to an implementation of the disclosed subject matter.

FIG. 4c shows another example illustration of a room with light emitters, according to an implementation of the disclosed subject matter.

FIG. 5a shows an example illustration of a scene, according to an implementation of the disclosed subject matter.

FIG. 5b shows another example illustration of a scene, according to an implementation of the disclosed subject matter.

FIG. 6 shows another example illustration of a scene, according to an implementation of the disclosed subject matter.

FIG. 7 shows an example illustration of multiple angles for light projection, according to an implementation of the disclosed subject matter.

### DETAILED DESCRIPTION

Activating one or more light emitters based on a light track a light calibration may enhance a user media experience by providing a visual component that is coordinated with the media content but is manifested beyond a display such as a television. The calibration profile may help ensure that the emitters output light with the correct timing, brightness, intensity, etc., based on their position in a room, their orientation, ambient light levels, other items in the room, etc. For example, an audio or light signal can be transmitted to the one or more light emitters and characteristics of the one or more emitters that receive the signals can be analyzed. Alternatively, or in addition, the light calibration may be generated based on transmitting an audio or light signal from one or more light emitters and analyzing characteristics of a receiver receiving the transmitted signal(s). Notably, the arrangement may gain an understanding of the layout of the one or more light emitters such that the one or more light emitters may be activated effectively. A light track associated with a media track (e.g., video track, audio track, text track, etc.) may be received and mapped onto the one or more light emitters based on the light calibration profile. The light track may, contain information regarding an intended output of light during activation of the media track. As an example, a video clip may be associated with a light track and, during playback of the video clip, the arrangement may activate one or more light emitters based on the light track and light calibration profile.

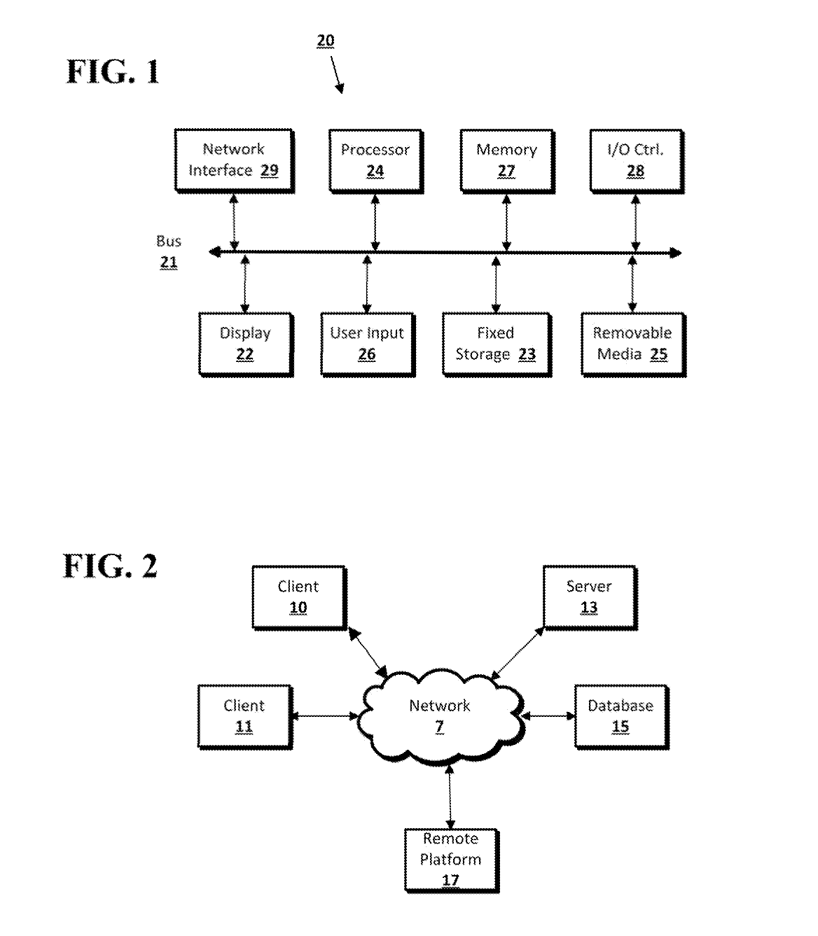

Implementations of the presently disclosed subject matter may be implemented in and used with a variety of component and network architectures. FIG. 1 is an example computer 20 suitable for implementing implementations of the presently disclosed subject matter. The computer 20 includes a bus 21 which interconnects major components of the computer 20, such as a central processor 24, a memory 27 (typically RAM, but which may also include ROM, flash RAM, or the like), an input/output controller 28, a user display 22, such as a display or touch screen via a display adapter, a user input interface 26, which may include one or more controllers and associated user input or devices such as a keyboard, mouse, WiFi/cellular radios, touchscreen, microphone/speakers and the like, and may be closely coupled to the I/O controller 28, fixed storage 23, such as a hard drive, flash storage, Fibre Channel network, SAN device, SCSI device, and the like, and a removable media component 25 operative to control and receive an optical disk, flash drive, and the like.

The bus 21 allows data communication between the central processor 24 and the memory 27, which may include read-only memory (ROM) or flash memory (neither shown), and random access memory (RAM) (not shown), as previously noted. The RAM can include the main memory into which the operating system and application programs are loaded. The ROM or flash memory can contain, among other code, the Basic Input-Output system (BIOS) which controls basic hardware operation such as the interaction with peripheral components. Applications resident with the computer 20 can be stored on and accessed via a computer readable medium, such as a hard disk drive (e.g., fixed storage 23), an optical drive, floppy disk, or other storage medium 25.

The fixed storage 23 may be integral with the computer 20 or may be separate and accessed through other interfaces. The fixed storage may store one or more light calibration profiles and/or a program that analyzes and generates the light calibration profiles. A network interface 29 may provide a direct connection to a remote server via a telephone link, to the Internet via an internet service provider (ISP), or a direct connection to a remote server via a direct network link to the Internet via a POP (point of presence) or other technique. The network interface 29 may provide such connection using wireless techniques, including digital cellular telephone connection, Cellular Digital Packet Data (CDPD) connection, digital satellite data connection or the like. For example, the network interface 29 may allow the computer to communicate with other computers via one or more local, wide-area, or other networks, as shown in FIG. 2.

Many other devices or components (not shown) may be connected or communicated with in a similar manner (e.g., light emitters, speakers, receivers, document scanners, image scanners, Bluetooth™ devices, digital cameras and so on). Conversely, all of the components shown in FIG. 1 need not be present to practice the present disclosure. The components can be interconnected in different ways from that shown. The operation of a computer such as that shown in FIG. 1 is readily known in the art and is not discussed in detail in this application. Code to implement the present disclosure can be stored in computer-readable storage media such as one or more of the memory 27, fixed storage 23, removable media 25, or on a remote storage location.

FIG. 2 shows an example network arrangement according to an implementation of the disclosed subject matter. One or more clients 10, 11, such as light emitters, receivers, local computers, smart phones, tablet computing devices, and the like may connect to other devices via one or more networks 7. The network may be a local network, wide-area network, the Internet, or any other suitable communication network or networks, and may be implemented on any suitable platform including wired and/or wireless networks. The clients may communicate with one or more servers 13 and/or databases 15. The devices may be directly accessible by the clients 10, 11, or one or more other devices may provide intermediary access such as where a server 13 provides access to resources stored in a database 15. The clients 10, 11 also may access remote platforms 17 or services provided by remote platforms 17 such as cloud computing arrangements and services. The remote platform 17 may include one or more servers 13 and/or databases 15.

More generally, various implementations of the presently disclosed subject matter may include or be implemented in the form of computer-implemented processes and apparatuses for practicing those processes. Implementations also may be implemented in the form of a computer program product having computer program code containing instructions implemented in non-transitory and/or tangible media, such as floppy diskettes, CD-ROMs, Blu-ray™ discs, DVD discs, hard drives, USB (universal serial bus) drives, or any other machine readable storage medium, wherein, when the computer program code is loaded into and executed by a computer, the computer becomes an apparatus for practicing implementations of the disclosed subject matter. Implementations also may be implemented in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Implementations may be implemented using hardware that may include a processor, such as a general purpose microprocessor and/or an Application Specific Integrated Circuit (ASIC) that implements all or part of the techniques according to implementations of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to implementations of the disclosed subject matter.

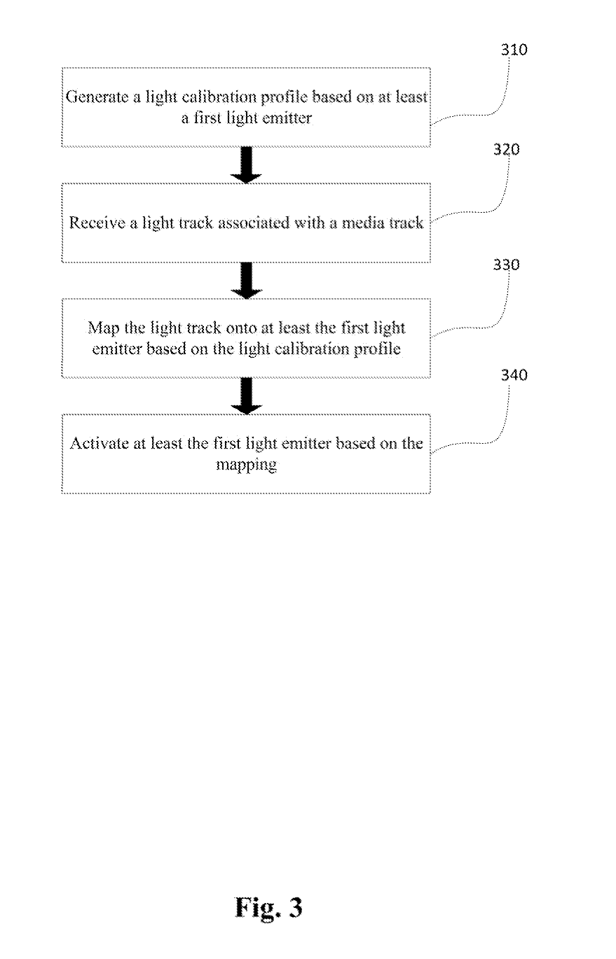

According to implementations of the disclosed subject matter, as shown in FIG. 3 at step 310, a light calibration profile based on at least a first light emitter may be generated. As disclosed herein, the light profile may contain characteristic information about the light emitter such as location, orientation, type, and the like. At step 320, a light track associated with a media track (e.g., video track, audio track, text track, etc.) may be received. The light track may be packaged with the media track in any applicable storage form such as a disc, a drive, a server, a flash drive, or the like. At step 330, the light track may be mapped onto at least the first light emitter based on the light calibration profile. For example, the mapping may determine that the light emitter is located 4 feet in front of a television and determine the delay in emission based on the location, as well as internal delays based on circuit-based delays at the emitter and transmitter, network delays, etc. At step 340, at least the first light emitter may be activated based on the mapping. For example, a video track may contain a blue ball rolling off the scene from the left side of the television. Thus, a light emitter to the left of the screen may emit a blue light 3 milliseconds after the blue ball rolls off the screen such that a user viewing the television may continue to experience the scene beyond the television screen. According to implementations of the disclosed subject matter, a light emitter may be any applicable object configured to emit one or more types of lights. The object may be located external to a display (e.g., a television set) and may be in communication with a display, media track player, processing device associated with a media track player (e.g., a receiver) either via a wired or wireless connection.

As shown in FIG. 3, at step 310, a light calibration profile may be generated based on a first light emitter. A light calibration profile contain any applicable light emitter information such as a light emitter location, a light emitter location relative to a reference point, a light emitter orientation, a light emitter type, a light emitter emission range, or the like, or a combination thereof. It will be understood that although a light calibration profile may be disclosed herein as based on one light emitter, the light calibration profile may be based on two or more light emitters.

A light emitter location or a light emitter location relative to a reference point may be determined according to the calibration techniques discussed herein. The location may be a distance (e.g., feet, yards, etc.) and may be calculated based on an X, Y, or Z axis. For example the arrangement may store the location of a light emitter in the following format:
(LE1, [1.3, 2.2, 0.4])

This format can indicate that light emitter LE1 is located 1.3 feet in front of, 2.2 feet to the left of, and 0.4 feet higher than a receiver. Alternatively, the arrangement may store the location of the light emitter in the following format:
(LE1, [4, 47])

This format can indicate that light emitter LE1 is located 4 feet away, at an angle of 47 degrees, from a receiver. Alternatively, the arrangement may store the location of the light emitter in the following format:
(LE1, LE2, [3, 14, 0])

This format can indicate that light emitter LE1 is located 3 feet away, at an angle of 14 degrees, from a second light emitter LE2. Also, the format may indicate that light emitter LE1 is the same height as LE2 (i.e., 0 feet above LE2). Other parameters in the format can include, without limitation, internal delays (e.g., in milliseconds), network latency, etc.

A light emitter orientation may be determined according to the calibration techniques discussed herein. The orientation may be an angle, an emission profile (e.g., which location(s) a light emitted by the light emitter may be visible, from what location(s) would a user be able to view the emitted light, etc.), or the like. As an example, the configuration profile may contain information that light emitter LE1 is oriented orthogonal (i.e., 90 degrees) to a television set. Alternatively, the configuration profile may contain information that light emitter LE1 is oriented such that the light emitted by light emitter LE1 may be viewed by a user located in specified areas of a room. As an example, the arrangement may store information regarding a light emitter LE1 in the following format:
(LE1, [1.3, 2.2, 0.4], 84)
   This format can indicate that light emitter LE1 is located 1.3 feet in front of, 2.2 feet to the left of, and 0.4 feet higher than a receive and also indicate that the light emitter faces 84 degrees respective of the receiver and/or television.

A calibration profile may contain information regarding a light emitter type for one or more light emitters. The light emitter type may identify a light emitter company, quality, age, capability, or the like. For example, the calibration profile may include the company and model number corresponding to a light emitter. Alternatively, or in addition, the calibration profile may include the response time required for the light emitter to emit a given light after the light emitter receives an indication to emit the light. More specifically, if a light emitter LE1 emits a light 1 ms after receiving an indication to emit the light, then the arrangement may, based on the calibration profile containing the respective information, include the 1 ms delay while calculating when to indicate to the light emitter to emit a light.

According to an implementation of the disclosed subject matter, a light calibration profile may be generated based on transmitting an audio signal via a calibration speaker. A calibration speaker may be located in any applicable location such that an audio signal output by the speaker can reach one or more light emitters that are included in the arrangement. The calibration speaker may be any applicable speaker configured to output an audio signal that is discernible by a receiver that receives the signal. A calibration receiver may be located in or near a media track player such as a Compact Disc player, a DVD Player, a Video Disk Player, an audio player, a Blu-ray™ player, a receiver, a television, a video game console, a media storage player, a media provide (e.g., an external component that communicates with a receive rand may be in communication with an external device such as a mobile device), or the like. An audio signal may be output by a calibration speaker and may be received by one or more audio receivers located at one or more light emitters. The audio receivers may be any applicable receivers configured to receive an audio signal. Further, the one or more audio receiver may be located on or proximate to one or more respective light emitters. For example, an audio receiver may be located at the base of a light emitter such that the audio signals may be received by the audio receiver.

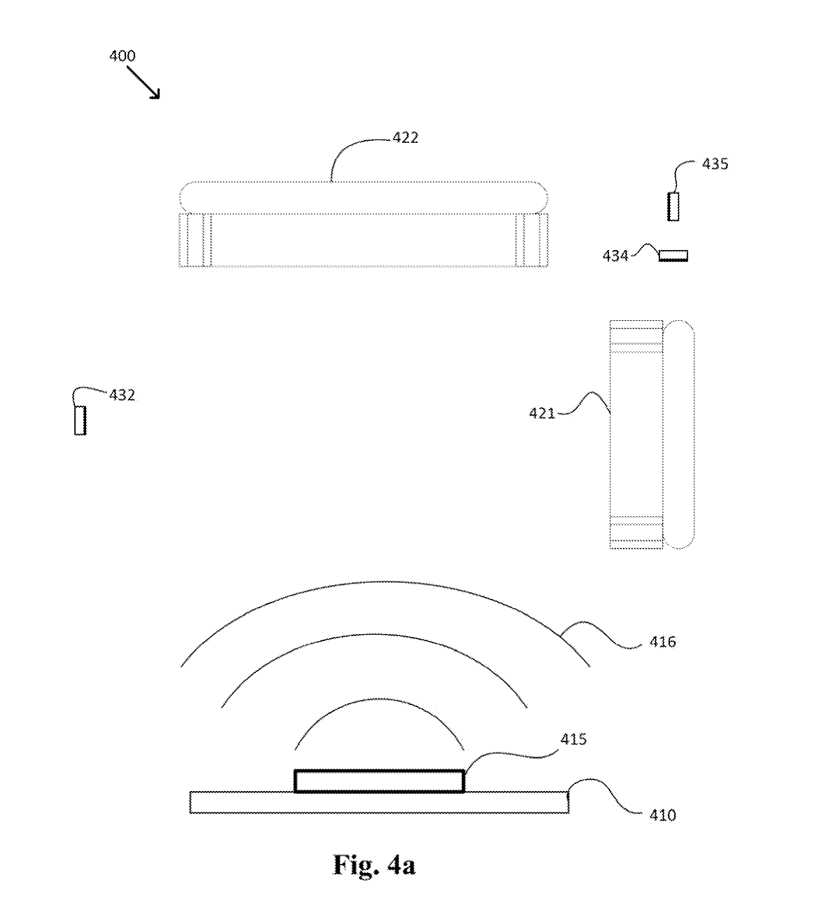

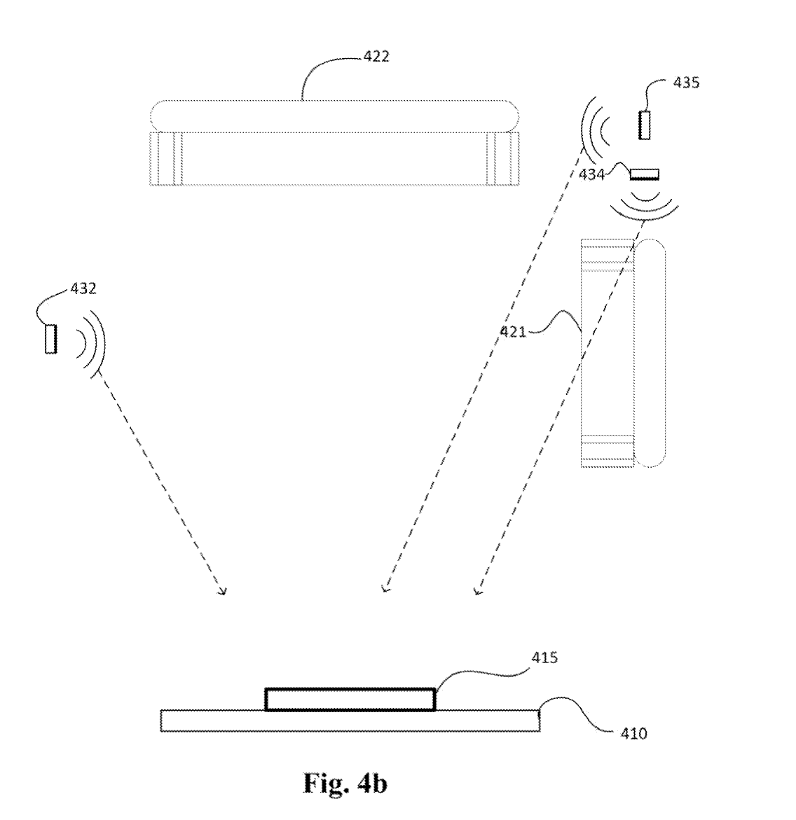

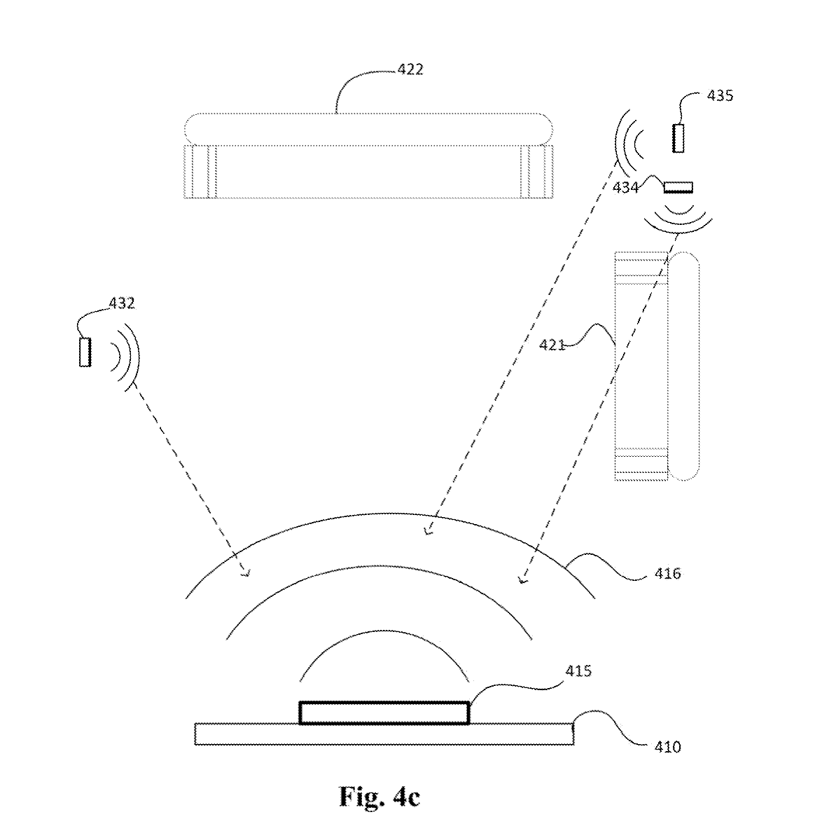

In an illustrative example, as shown in FIG. 4a, a central home audio/video receiver 415 may be located below a television 410. The room where the central home audio/video receiver 415 is located may also contain light emitters 432, 434 and 435 as well as couches 421 and 422. The central home audio/video receiver 415 may output an audio signal 416 that is received by audio receivers located at light emitters 432, 434 and 435. A light calibration profile may be generated based on the received audio signal.

The arrangement may analyze the audio signal received by the one or more light emitter audio receivers and determine one or more characteristics of the received audio signals. The analysis may be based on duration between transmitting and receiving the audio signal (e.g., the longer the duration the further the light emitter may be located), intensity (e.g., the more intense the sound the clearer the path between the calibration speaker and the light emitter may be), a decibel value (e.g., a higher decibel value may indicate that the light emitter is close to a calibration speaker), and an angle of incidence (e.g., a light emitter orientation may be determined based on analysis of the audio signal wavelength or intensity). As an example, the duration of time between when the signal is transmitted by a calibration speaker and when the signal is received by a first light emitter audio receiver may enable the arrangement to determine the distance between the speaker and light emitter. Further, the duration of time for a second light emitter to receive the signal may be larger than the original light emitter, essentially indicating that the second light emitter is further away from the calibration speaker than the original light emitter.

According to an implementation of the disclosed subject matter, a light calibration profile may be generated based on transmitting an audio signal from one or more audio transmitters located at respective one or more light emitters. The audio transmitters may be located on or near the one or more light emitters and may be representative of a property of a respective light emitter. For example, an audio transmitter corresponding to light emitter LE1 may face west based on the light emitter LE1 facing west (i.e., light emitted by the light emitter LE1 may direct west). The audio signal transmitted by one or more transmitters may be received by a calibration speaker. For example, an audio signal transmitted by an audio transmitter located at a light emitter LE1 may be received by a calibration speaker located at the center of a room.

In an illustrative example, as shown in FIG. 4b, light emitters 432, 434 and 435 may also contain respective audio transmitters located at the top of each light emitter. The room where the light emitters 432, 434 and 435 are located may also contain a central home audio/video receiver 415 as well as couches 421 and 422. The central home audio/video receiver 415 may receive audio signals from the audio transmitters located at each of the light emitters 432, 434 and 435. A light calibration profile may be generated based on the received audio signal.

The arrangement may analyze the audio signal received by a calibration microphone. The analysis may be based on duration between transmitting and receiving the audio signal (e.g., the longer the duration the further the light emitter may be located), intensity (e.g., the more intense the sound the clearer the path between the light emitter and the calibration microphone), a decibel value (e.g., a higher decibel value may indicate that the light emitter is close to a calibration speaker), and an angle of incidence (e.g., a light emitter orientation may be determined based on analysis of the audio signal wavelength or intensity). As an example, a first light emitter that is oriented away from a receiver may contain an audio transmitter that is also facing away from the receiver. A second light emitter that is oriented towards the receiver may contain an audio transmitter that is also oriented towards the receiver. Both the audio transmitters for the first and the second light emitters may emit an audio signal at the same time. The receiver may receive both the transmitted audio signals and determine the orientation of each light emitter based on the intensity of the signal from the first audio transmitter being significantly lower than the intensity of the signal of the second audio transmitter.

According to an implementation of the disclosed subject matter, a light calibration profile may be generated based on transmitting a light signal via a calibration emitter. A calibration emitter may be located in any applicable location such that a light signal output by the emitter can reach one or more light emitters that are included in the arrangement. The calibration emitter may be any applicable light source configured to output a light signal that may be received by a light receiver. A calibration emitter may be located in or near a media track player such as a Compact Disc player, a DVD Player, a Video Disk Player, an audio player, a Blu-ray™ player, a central receiver, or the like. A light signal may be output by a calibration emitter and may be received by one or more light receivers located at one or more light emitters. The light receivers may be any applicable receivers configured to receive a light signal. Further, the one or more light receiver may be located on or proximate to one or more respective light emitters. For example, a light receiver may be located at the base of a light emitter such that the audio signals may be received by the audio receiver. In an illustrative example, as shown in FIG. 4a, a central home audio/video receiver 415 may be located below a television 410. The room where the central home audio/video receiver 415 is located may also contain light emitters 432, 434 and 435 as well as couches 421 and 422. The central home audio/video receiver 415 may output a light signal 416 that is received by light receivers located at light emitters 432, 434 and 435. A light calibration profile may be generated based on the received light signal.

The arrangement may analyze the light signal received by the one or more light emitter light receivers and determine one or more characteristics of the received light signals. The analysis may be based on duration between transmitting and receiving the light signal (e.g., the longer the duration the further the light emitter may be located), intensity (e.g., the higher the luminance value of the light signal, the clearer the path between the calibration emitter and the light emitter may be), a color value (e.g., matching transmitted and received color value may indicate minimal disturbance between the calibration emitter and light emitters), and an angle of incidence (e.g., a light emitter orientation may be determined based on analysis of the light signal wavelength and/or intensity). As an example, the duration of time between when the signal is transmitted by a calibration emitter and when the signal is received by a first light emitter light receiver may enable the arrangement to determine the distance between the calibration emitter and light emitter. Further, the duration of time for a second light emitter light sensor to receive the signal may be larger than the original light emitter, essentially indicating that the second light emitter is further away from the calibration emitter than the original light emitter.

According to an implementation of the disclosed subject matter, a light calibration profile may be generated based on transmitting a light signal from one or more light emitters. The light signal transmitted by one or more light emitters may be received by a calibration receiver. For example, a light signal transmitted by a light emitter LE1 may be received by a calibration receiver located at the center of a room. In an illustrative example, as shown in FIG. 4b, a room may contain light emitters 432, 434 and 435 as well as a central home audio/video receiver 415 and couches 421 and 422. The central home audio/video receiver 415 may receive light signals from light emitters 432, 434 and 435. A light calibration profile may be generated based on the received audio signal.

The arrangement may analyze the light signal received by a calibration receiver. The analysis may be based on duration between transmitting and receiving the light signal (e.g., the longer the duration the further the light emitter may be located), intensity (e.g., the higher the luminance value of the light signal, the clearer the path between the calibration emitter and the light emitter may be), a color value (e.g., matching transmitted and received color value may indicate minimal disturbance between the calibration emitter and light emitters), and an angle of incidence (e.g., a light emitter orientation may be determined based on analysis of the light signal wavelength and/or intensity), and an angle of incidence (e.g., a light emitter orientation may be determined based on analysis of the audio signal wavelength or intensity). As an example, a first light emitter may be oriented away from a receiver. A second light emitter may be oriented towards the receiver. Both the first and second light emitters may emit a light at the same time. The calibration receiver may receive both the transmitted light signals and determine the orientation of each light emitter based on the intensity of the signal from the first light emitter being significantly lower than the intensity of the signal of the second light emitter.

According to implementations of the disclosed subject matter, as shown at step 320 of FIG. 3, a light track associated with a media track may be received. A media track may be any applicable track/media type such as a video track, audio track, text track, and, as specific examples, may be an .avi, .mpg, .mpeg, .zip, .dat, .fla, .m4v, .mov, .mp3, .wav, .txt or the like. The media track may be associated with one or more other tracks in addition to the light track such as, for example, a video track may be associated with an audio track and a subtitles text track. The light track may be stored on the same medium as the media track, or, alternatively, may be stored on a different medium. The storage medium may be any applicable medium such as a CD-ROM, Blu-ray™ disc, DVD disc, hard drive, USB (universal serial bus) drives, solid state drive, or the like. The media track and/or light track may be received at a media track player such as a computer, a Compact Disc player, a DVD Player, a Video Disk Player, an audio player, a Blu-ray™ player, a central receiver, or the like, or the media track player may be the same component that is used to generate a configuration profile (e.g., send/receive an audio/video signal and/or analyze the sent/received audio/video signal). Alternatively, a first component may be used to generate the configuration profile and a media track player may receive the media track and/or the light track.

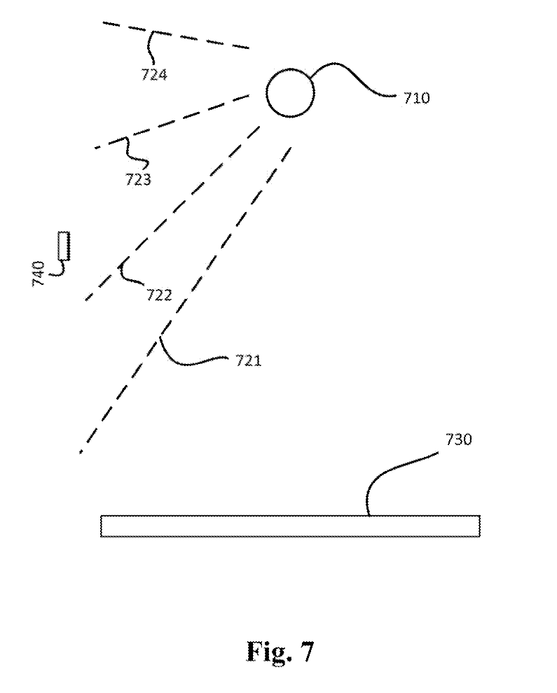

A light track may contain light emission information such that the light emission information corresponds to the media track associated with the light track. At step 330, the light track associated with a media track may be mapped onto one or more light emitters based on the calibration profile. Essentially, a light track may contain information regarding light activation indications for light emitters. A light activation indication can be a signal, messages, requests, or the like sent to light emitters instructing, requesting, or controlling the light emitter such that the light emitter emits a light signal. Alternatively or in addition, a light track may contain information that allows the arrangement to generate light activation indication for light emitters. As an example, as shown in FIG. 7, the light track may contain information regarding a blue light corresponding to an object that goes off a television screen 730. The information contained in the light track may include a light projection schedule that stats that at 1 ms, the user should view the blue light at an angle of 25 degrees 721, at 2 ms, at an angle of 45 degrees 722, at 3 ms, at an angle of 80 degrees 723, and at 4 ms at an angle of 95 degrees 724. The arrangement may generate a light activation time based on a determination that light emitter 740 is located at an angle of 50 degrees. Accordingly, the arrangement may instruct the light emitter 740 to emit a blue light at 2.2 ms to comply with the light projection schedule included in the light track.

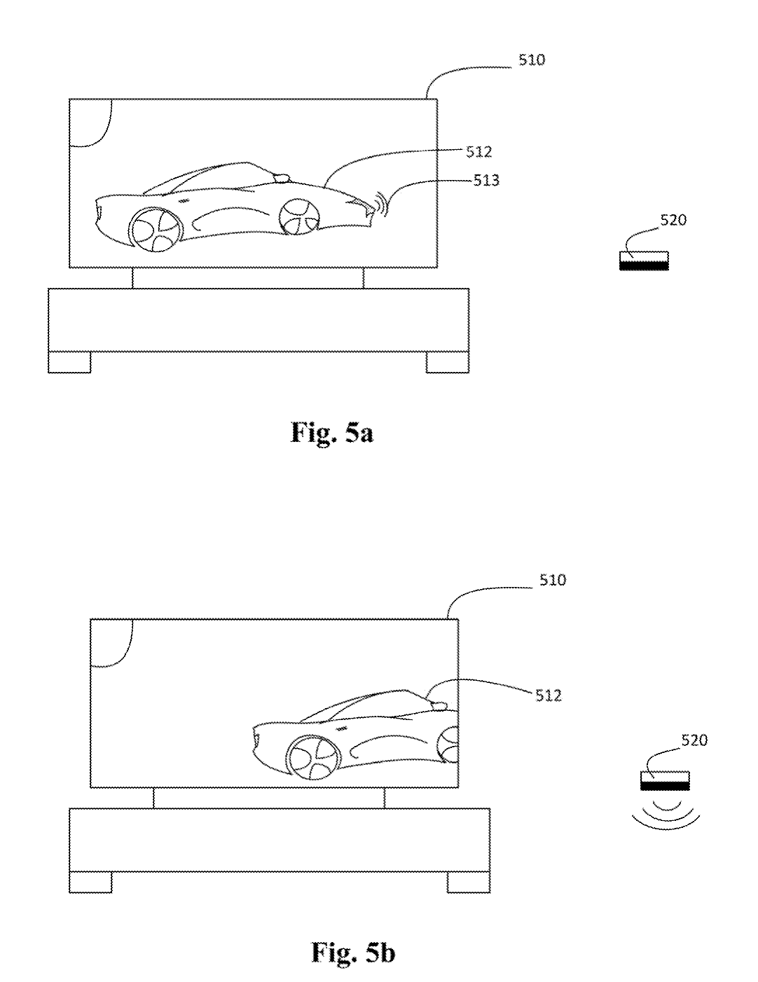

At step 340, one or more light emitters may be activated based on the mapping. The activation may be a result of a light activation indication, as discussed herein. As an illustrative example, as shown in FIGS. 5a and 5b, a first scene may be displayed on a television 510 and may contain a car 512 with a yellow light 513 emitting from its headlights. A light emitter 520 may be inactivated such that it may not emit a light while the car 512 and yellow light 513 are both present in the scene on the television 510. In FIG. 5b, a second subsequent scene may be shown on the television 510 and may contain the car 512 shifted to the right such that the yellow light 513 is no longer displayed on the television. During the second scene, light emitter 520 may emit a yellow light to imitate the light the car 512 would emit if the display extended beyond the television.

A light track may contain light activation indications based on timestamps, metadata, or the like. A timestamp based light activation indication may associate light emissions with a specific time for when those light emissions should occur. As an example, the light track may contain information indicating that at 2 minutes and 47 seconds, a red light should be emitted and travel towards the left side of a viewer. The arrangement may emit a red light at a first light emitter LE1 located to the left of a television and, at 2 minutes 47 seconds and 5 milliseconds at a second light emitter LE2 located to the left of LE1. Alternatively, a metadata based light activation indication may associate light emission with a specific action or even that occurs related to the media track. The action or event may be the presence of an object (e.g., a person, an item, a sound, a color, a change, etc.), may be an action by a user (e.g., selection of a button, voice command, gesture, etc.), or the like. For example, the metadata may include a rapid change in color on a display that shifts from one side of the display to the other. Here, the change in color may continue off the screen via one or more light emitters.

A light track may be activated along with a media track automatically or may be activated separate from the media track. For example, a media track player may activate both the light track and the media track when a user opts for media track activation. Alternatively, a device may recognize that a media track is activated and activate a corresponding light track based on the recognition. A light track property may be modified automatically by the arrangement or manually by a user when via any applicable interface such as a mobile application (e.g., for a mobile phone or tablet), a computer software, a television software, or the like.

According to an implementation of the disclosed subject matter, a light track may be generated based on a video game characteristic. A video game characteristic may be any applicable characteristic such as a character location, a scene, a change in a character location, a change in scene, an object, a change in an object, or the like. Essentially, a light track may be generated based on a current characteristic and/or a change in a current characteristic. As an example a user may play a videogame via a videogame console and control the video game via a controller held by the user. The user may direct a character in the game to throw an orange ball via the video game controller and, based on the direction by the user, a light track may be generated that directs one or more light emitters to emit an orange light corresponding to the direction of the thrown ball.

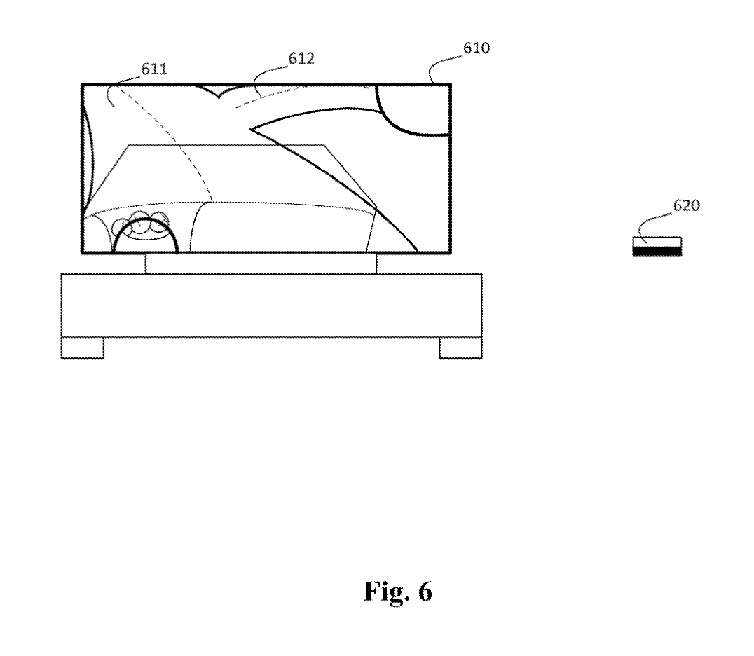

In an illustrative example, as shown in FIG. 6, a user may play a videogame via a videogame console and control the video game via a controller held by the user. The video game may be displayed on a television 610 and the user may have control of a car that is currently on a straight road 611. A light emitter 620 may not emit a light while the user is on the straight road 611. However, if the user directs the car, via the controller, to turn right onto road 610, then light emitter 620 may emit a yellow light to imitate the car's headlights. The light emitter 620 may emit the light based on a light track that is generated when the user directs the car to turn right via the controller.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

1. A method comprising:
generating a light calibration profile based on at least a first light emitter;
receiving a light track associated with a media track;
mapping the light track onto at least the first light emitter based on the light calibration profile; and
activating at least the first light emitter based on the mapping.

2. The method of claim 1, further comprising:
generating the light calibration profile based on the first light emitter and a second light emitter;
mapping the light track onto the first light emitter and the second light emitter based on the light calibration profile; and
activating the first light emitter and the second light emitter based on the mapping.

3. The method of claim 1, wherein the light track contains light activation indications based on timestamps.

4. The method of claim 1, wherein the light track contains light activation indications based on metadata.

5. The method of claim 1, wherein the light calibration profile comprises characteristic information selected from the group consisting of: a light emitter location, a light emitter location relative to a reference point, a light emitter type, a light emitter orientation, and a light emitter emission range.

6. The method of claim 1, wherein the media track is selected from the group consisting of: a video file, an audio file, a text file.

7. The method of claim 1, wherein the light calibration profile is generated by a processing device associated with a media track player.

8. The method of claim 7, wherein the media track player is selected from the group consisting of: a television, a video game console, a media storage player, a receiver, and a media provider.

9. The method of claim 7, wherein the media track player wirelessly communicates with the first light emitter.

10. The method of claim 7, wherein the media track player transmits light activation indications to the first light emitter.

11. The method of claim 7, wherein the light calibration profile is stored at the media track player.

12. The method of claim 1, wherein the light calibration profile is based on a plurality of light emitters.

13. The method of claim 1, wherein the light calibration profile is generated based on:
transmitting an audio signal via a calibration speaker;
receiving the audio signal at a first audio receiver located at the first light emitter; and
generating the light calibration profile based on at least a first characteristic of receiving the audio signal.

14. The method of claim 11, wherein the first characteristic is selected from the group consisting of: a duration between transmitting and receiving the audio signal, an intensity, a decibel value, and an angle of incidence.

15. The method of claim 1, wherein the light calibration profile is generated based on:
transmitting an audio signal from a first audio transmitter located at the first light emitter;
receiving the audio signal at a calibration microphone;
and
generating the light calibration profile based on at least a first characteristic of receiving the audio signal.

16. The method of claim 15, wherein the first characteristic is selected from the group consisting of: a duration between transmitting and receiving the audio signal, an intensity, a decibel value, and an angle of incidence.

17. The method of claim 1, wherein the light calibration profile is generated based on:
transmitting a light signal via a calibration emitter;
receiving the light signal at a first light receiver located at the first light emitter; and
generating the light calibration profile based on at least a first characteristic of receiving the light signal.

18. The method of claim 17, wherein the first characteristic is selected from the group consisting of: a duration between transmitting and receiving the light signal, a wavelength, an intensity, a luminance value, and an angle of incidence.

19. The method of claim 1, wherein the light calibration profile is generated based on:
transmitting a light signal from the first light emitter;
receiving the light signal at a calibration receiver; and
generating the light calibration profile based on at least a first characteristic of receiving the light signal.

20. The method of claim 19, wherein the first characteristic is selected from the group consisting of: a duration between transmitting and receiving the light signal, an intensity, a luminance value, and an angle of incidence.

21. The method of claim 1, further comprising generating the light track based on a video game characteristic.

22. The method of claim 21, wherein the video game characteristic is selected form the group consisting of: a character location, a scene, a change in a character location, a change in scene, an object, and a change in an object.
